(19) United States
(12) Patent Application Publication
(10) Pub. No.: US 2015/0270049 A1
(43) Pub. Date: Sep. 24, 2015

(54) MAGNETIC ELEMENT AND CORE THEREOF

(71) Applicant: Delta Electronics (Shanghai) Co., Ltd., Shanghai (CN)

(72) Inventors: Zengyi Lu, Shanghai (CN); Shaohua Zhu, Shanghai (CN); Weilong Xia, Shanghai (CN); Jinfa Zhang, Shanghai (CN)

(21) Appl. No.: 14/661,939

(22) Filed: Mar. 18, 2015

(30) Foreign Application Priority Data
Mar. 19, 2014 (CN) 201410103101.1

(51) Int. Cl. H01F 27/24

(52) U.S. Cl. CPC H01F 27/24

(57) ABSTRACT

The present application discloses a magnetic element comprising two opposed cores, a conductive winding disposed therebetween, and gaps comprised between said two cores; at least one of the two cores comprising a plurality of joint faces and a plurality of bosses, the joint faces being adapted for jointing the opposed core, and the plurality of bosses being disposed on the joint faces to provide a mechanical support for the opposed core, wherein the bosses have a height dimension which is used for substantially controlling the sizes of the gaps. According to the present application, bosses are disposed on the joint faces of a core so that gaps are dispersed over all the magnetic columns of the core, thereby effectively reducing a range of inductance tolerance and improving the consistency of the magnetic element.

### CROSS-REFERENCE TO RELATED APPLICATIONS

This non-provisional application claims priority under 35 U.S.C. §119(a) on Patent Application No. 201410103101.1 filed in P.R. China on Mar. 19, 2014, the entire contents of which are hereby incorporated by reference.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### FIELD OF THE APPLICATION

The present application relates to a magnetic element, and more particularly relates to a core of a magnetic element.

### BACKGROUND

In a magnetic element such as an inductor or a transformer, a gap is a very important part of a magnetic circuit and has significant impacts on the inductance value, saturation current, and frequency characteristics of the magnetic element. Therefore, the material, size, position, and bonding strength of a gap are key factors that need to be controlled in the production of magnetic elements.

The core of the magnetic element with a gap is usually made from ferrite material which is hard and brittle. The core generally has a structure of EI, EE, EQ, RM or the like with three magnetic columns (i.e., three contact faces). In order to get an inductance with a relatively narrow range of tolerance, a gap is usually disposed on the center column of the core. Grinding machines are used to ground the gap such that the center column is below the contact faces of two lateral magnetic columns. The tolerance can be generally controlled within a range of ±5%. The gap formed on the center column is single gap, which makes magnetic field excessively gathered. Diffusion flux formed by the gap may cause a great AC power loss of a winding, resulting in heat emission of the magnetic element and decrease of efficiency.

In order to reduce the diffusion flux formed by the single gap, the gap concentrated on the center column of the core can be dispersed over three different magnetic columns. Currently, the size of a gap is often substantially set relative to the thickness of an insulation sheet (e.g., Mylar). As shown in FIG. 1, the cores of a magnetic element comprise a core 20 (of Type EQ) and a core 10 (of Type I), and a conductive winding 40 has a PCB structure. A Mylar sheet 30 is disposed between the joint faces of the EQ core 20 and the I core 10, and the two side columns of the cores have essentially the same cross-sectional area. In FIG. 1, the gap on a side column corresponds to a cross-sectional area of AA on the core, and the gap distance (i.e., the size of the gap) between the EQ core and the I core is substantially set relative to the thickness of the Mylar sheet so as to control the inductance. Three gaps formed in this way have essentially the same size. An insulation sheet (e.g., a Mylar sheet) is used to disperse the gaps over three magnetic columns, which can reduce the loss of diffusion flux of gaps and achieve higher efficiency, compared to a concentrated gap. But, limited by a thickness tolerance of Mylar, the inductance tolerance of the magnetic element is normally within a range of ±25% or more, which makes it extremely difficult to ensure the consistency of power supply products and affects the reliability and stability of circuits.

### SUMMARY OF THE APPLICATION

It is an object of present application to provide a core to effectively reduce the range of inductance tolerance and obtain a dispersed gap frame.

To achieve the above object, a core according to the present application comprises a plurality of joint faces and a plurality of bosses. The plurality of joint faces are adapted for jointing another core; the plurality of bosses are disposed on the joint faces to provide a mechanical support for the other core; wherein there are gaps between said core and said other core, and the sizes of the gaps are substantially set relative to a height of the bosses.

Furthermore, the present application provides a magnetic element with high consistency.

To achieve the above object, a magnetic element according to the present application comprises two cores substantially disposed oppositely, a conductive winding disposed therebetween, and gaps comprised between said two cores. At least one of the two cores comprises a plurality of joint faces and a plurality of bosses. The plurality of joint faces are adapted for jointing the opposed core. The plurality of bosses are disposed on the joint faces to provide a mechanical support for the opposed core. The sizes of the gaps are substantially set relative to a height of the bosses.

In the present application, a plurality of bosses are disposed on the joint faces of the core and provide a mechanical support instead of the Mylar sheets, and the sizes of the gaps in the magnetic element can be substantially set relative to a height dimension of the bosses. Thus it can be ensured that the gaps are dispersed over all the magnetic columns of the cores, thereby effectively reducing a range of inductance tolerance and improving the consistency of the magnetic element.

Hereinafter, the present application is described in detail with reference to the accompanying drawings and embodiments, which are not intended to limit the present application.

### BRIEF DESCRIPTION OF THE DRAWINGS

FIG. 1 is a structure diagram of a magnetic element in the prior art;

FIG. 2a is a perspective of a core according to a first embodiment of the present application;

FIG. 2b is a top view of the core shown in FIG. 2a;

FIG. 3a is a perspective of a core according to a second embodiment of the present application;

FIG. 3b is a top view of the core shown in FIG. 3a; and

FIG. 4 is a perspective of a magnetic element according to an embodiment of the present application.

### DESCRIPTION OF THE PREFERRED EMBODIMENTS

Hereinafter, the technical solution of the present application is described in detail with reference to the accompanying drawings and embodiments, so as to further understand the objectives, features and advantages of the invention, but not to limit the scope of the appended claims of the present application.

Prior to a detailed description of the present application, the terms or words, which are used in the specification and claims to be described below, should not be construed as having typical or dictionary meanings The terms or words should be construed in conformity with the technical idea of the present application on the basis of the principle that the inventor(s) can appropriately define terms in order to describe his or her application in the best way. Embodiments described in the specification and structures illustrated in drawings are merely exemplary embodiments of the present application. Thus, it is intended that the present application covers the modifications and variations of this application, provided they fall within the scope of their equivalents at the time of filing this application.

Exemplary embodiments of the present application will be described in detail with reference to the accompanying drawings. The same reference numerals will be used throughout to designate the same or like elements in the accompanying drawings. Moreover, detailed descriptions related to well-known functions or configurations will be ruled out in order not to unnecessarily obscure subject matters of the present application. In the drawings, the shapes and dimensions of some elements may be exaggerated, omitted or schematically illustrated. Also, the size of each element does not entirely reflect an actual size.

Exemplary embodiments of the present application will now be described in detail with reference to the accompanying drawings.

According to the present application, basically, bosses are disposed on the joint faces of an core and provide mechanical support instead of the known Mylar sheets, and the sizes of gaps in a magnetic element are substantially set relative to a height dimension of the bosses. Thus it can be ensured that the gaps are dispersed over all the magnetic columns of the core, thereby effectively reducing a range of inductance tolerance and improving the consistency of the magnetic element. The core of the present application will be introduced in detail with reference to a plurality of embodiments.

### 1

### First Embodiment

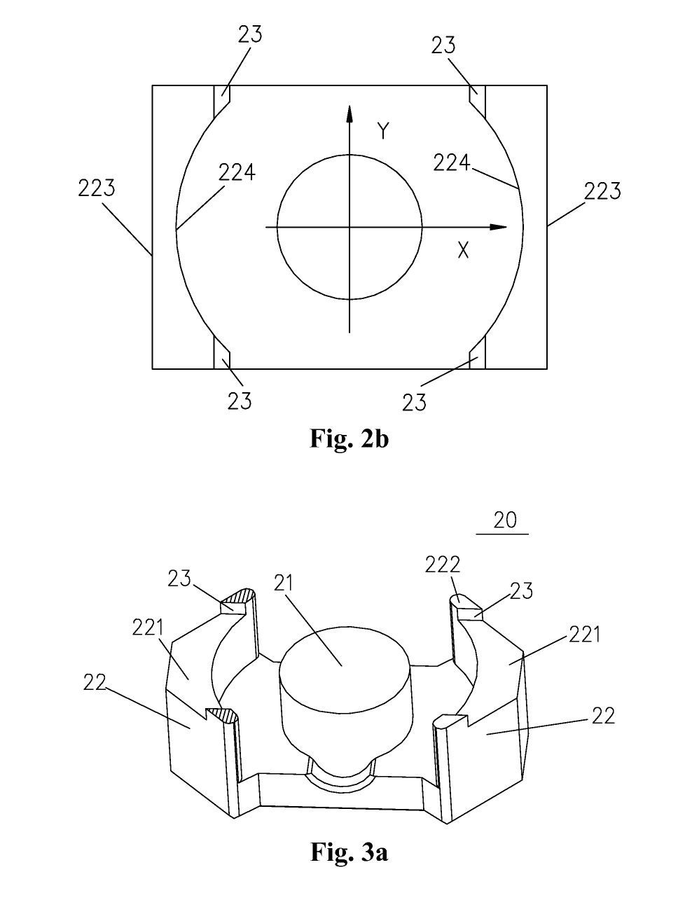

To make gaps dispersed and effectively narrow a range of inductance tolerance, a core according to a first embodiment of the present application is shown in FIGS. 2a and 2b. The core 20 comprises a plurality of joint faces 221 and a plurality of bosses 23. Joint faces 221 are used to joint another core. The plurality of bosses 23 are disposed on joint faces 221 to provide a mechanical support for the other core, and the bosses 23 have a height dimension which is used for substantially controlling the size of gaps in a magnetic element.

In this embodiment, the core EQ is taken as an example. The core 20 comprises a center column 21 and two side columns 22 disposed on the periphery of the center column 21. The joint faces refer to the joining surfaces of two cores without bosses at the time of assembling. As shown in FIG. 2a, said joint faces 221 include a joint face of the center column and joint faces of the side columns. In the absence of bosses 23, an upper surface of the center column 21 joints the other core, thereby the upper surface of the center column is the joint face of the center column; and upper surfaces of side columns 22 also joint the other core, thereby the upper surfaces of the side columns are the joint faces of the side columns. In this embodiment, bosses 23 are disposed on the joint faces of the side columns. When the core 20 serves as a component of a magnetic element, the upper surfaces of the bosses 23 adhere closely to the other core. Due to the supporting effect of the bosses 23, the core 20 and the other core can be assembled with a mechanically inherent stability.

Further, in order to achieve a better supporting effect of the bosses 23, the joint face of a side column 22 at least comprises a first side edge 223 far from the center column 21 and a second side edge 224 near the center column 21, and the bosses 23 are substantially disposed on both ends of the second side edge 224.

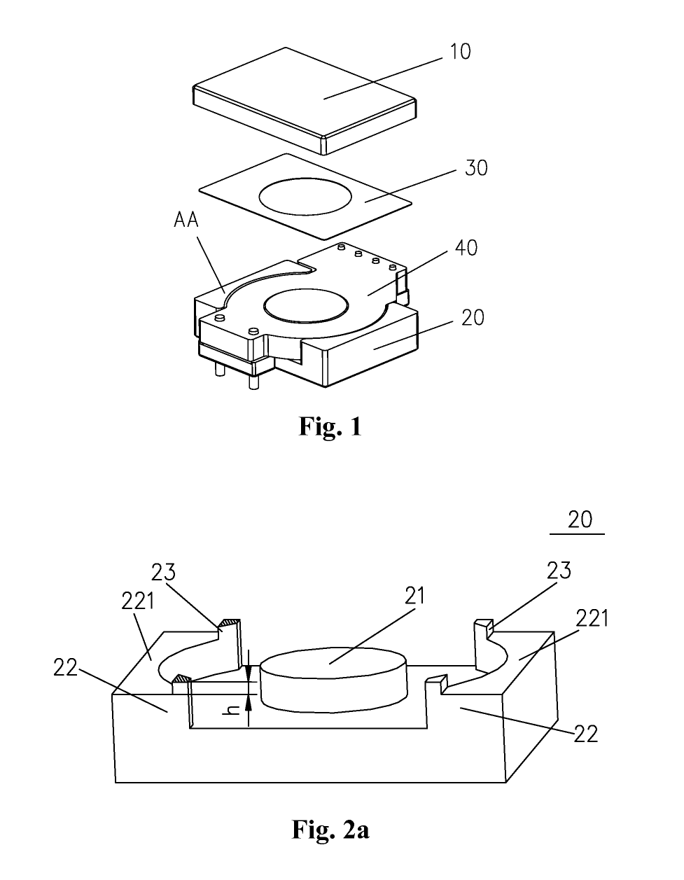

In order to achieve a better function of controlling the sizes of gaps in the magnetic element, a height of the center column 21 is less than or equal to the sum of a height of a side column 22 and a height of a boss 23. Preferably, the height of the center column 21 is equal to the height of the side column 22. The bosses have a height dimension which is represented by h, thus h is proportional to the height of the gaps between the combined upper and lower cores. The height of the bosses 23 has the same function as the thickness of the Mylar sheet as shown in FIG. 1, i.e., controlling the size of gaps.

In contrast to the approach shown in FIG. 1, small-area bosses 23 are locally disposed on the joint faces of the two side columns of the EQ core, instead of the traditional Mylar sheet, The distance between the upper and lower cores is substantially set relative to the height dimension h of the bosses, so as to control the size of gaps, get the desired inductance and reduce the range of the inductance tolerance. Bosses can also act as a support so as to achieve a mechanically inherent stability when cores are assembled.

In the present application, the main objects of bosses 23 are controlling the size of gaps on the magnetic path and providing a mechanical support. In order to avoid bosses influencing the other electrical properties of the magnetic element, the cross-sectional areas of the bosses should be as small as possible in practical applications.

The corresponding cross-sectional area (i.e., the area of a joint face 221) of a side column (e.g., the side column on the left) in FIG. 2a is the same as that shown in FIG. 1 and represented by area AA. The sum of the cross-sectional areas of the two bosses 23 on the left side column is represented by area BB (the shaded area as shown in FIG. 2a), and area AA comprises area BB, i.e., the sum of the cross-sectional areas of the plurality of bosses on the same one joint face is less than the area of the joint face where they are disposed. In the present application, k is further defined as a ratio of area BB to area AA (i.e., k=BB/AA), and k is preferably selected from values in a range of less than 1/5, i.e., the ratio of the sum of the cross-sectional areas of the plurality of bosses on the same one joint face to the area of the joint face where they are disposed is less than 1/5. It is described again that area BB refers to a sum of the cross-sectional areas of the plurality of bosses on the same one joint face, and area AA refers to the area of the same one joint face where the plurality of bosses are disposed.

In this embodiment, the center column 21 is defined as having a first axial direction (Y-axis in FIG. 2b) and a second axial direction (X-axis in FIG. 2b) that are perpendicular to each other. Bosses 23 are formed by grinding along the Y-axis, and they need to be divided into three portions for grinding. After grinding, each of the left and right side columns of the EQ core has two bosses, and the upper surfaces of the four bosses adhere closely to the opposite core so as to form new composite surfaces.

It has to be noticed that the core used in this embodiment is an EQ core with two side columns, but in practical applications, the number of side columns is not limited to two but may also be more than two.

### 2

### Second Embodiment

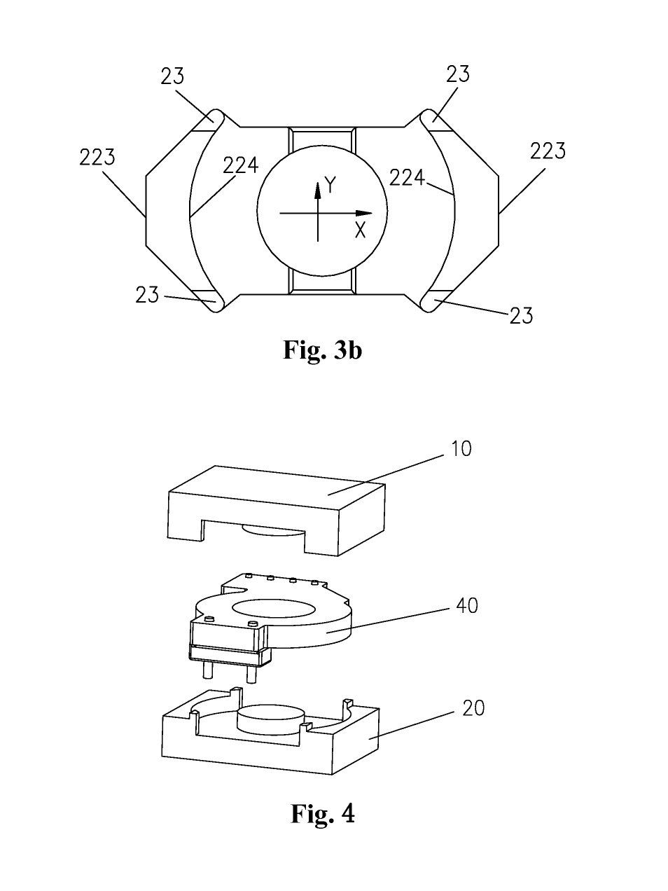

Another embodiment of the present application is shown in FIGS. 3a and 3b. A core according to this embodiment has substantially the same structure as the core according to the first embodiment, except that the core is of a different type. The core used in this embodiment is a RM core, whereas the core used in the first embodiment is an EQ core. Bosses 23 are formed by grinding along the X-axis, thus reducing the times of grinding.

In this embodiment, there are two bosses on each of the left and right side columns of the RM core, and the upper surfaces of the four bosses adhere closely to the opposed core so as to form new composite surfaces.

The main difference between a magnetic element of the present application and a magnetic element in the prior art lies in the structure of a core. Specifically, a magnetic element of the present application uses a core as described in the above embodiments. Examples are given below for illustration.

FIG. 4 is a structure diagram of a magnetic element according to an embodiment of the present application. The magnetic element comprises two oppositely disposed cores 10, 20 and a conductive winding 40 disposed between the two cores 10, 20. The conductive winding 40 is of a PCB structure. Wherein, the core 20 is a core as shown in FIGS. 2a and 2b. Bosses 23 are disposed such that the size of gaps between the two cores can be substantially set relative to a height dimension of bosses 23. When a height of a center column 21 is less than a sum of the heights of a side column 22 and a boss 23, the gaps between the two cores include a first gap formed on the position of the center column and a second gap formed on the side columns by the bosses 23 supporting an opposed core 10, wherein the second gap has a stepped structure. Further, when the height of the center column 21 is equal to the sum of the heights of a side column 22 and a boss 23, a gap is formed on the side columns by the bosses 23 supporting the opposed core 10, wherein the gap has a stepped structure.

It has to be noticed that, for a magnetic element, the bosses are not limited to be merely disposed on the joint faces of the core 20 or disposed on the joint faces of both of the cores 10 and 20, but may also be merely disposed on the joint face of core 10.

Moreover, although the present application only exemplifies a magnetic element using a core according to the first embodiment, the magnetic element is not limited to the abovementioned structure, and in practice, a core according to the second embodiment may also be used in the magnetic element. Examples will not be given one by one herein. Further, the structure of the magnetic element is not limited to those illustrated in the above embodiments. Any magnetic element should fall in the scope of the present application, as long as there are bosses on the joint faces, which is adapted for jointing an opposed core, of at least one core of the magnetic element.

Of course, the present application may have a variety of other embodiments. Those skilled in the art can make various corresponding changes and modifications according to the present application without departing from the spirit and essence of the present application, but all these changes and modifications should fall in the scope of the appended claims of the present application.

What is claimed is:

1. A core, comprising:
a plurality of joint faces for jointing another core; and
a plurality of bosses disposed on the joint faces to provide a mechanical support for the other core,
wherein there are gaps between said core and said other core, and the sizes of gaps are substantially set relative to a height of said bosses.

2. The core according to claim 1, wherein a sum of the cross-sectional areas of said plurality of bosses on the same joint face is less than the area of the joint face where they are disposed.

3. The core according to claim 2, wherein a ratio of the sum of the cross-sectional areas of said plurality of bosses on the same joint face to the area of the joint face where they are disposed is less than 1/5.

4. The core according to claim 1, comprising a center column and a plurality of side columns substantially disposed on the periphery of said center column, wherein said plurality of joint faces include a joint face of said center column, and said bosses are disposed on said joint faces of the side columns.

5. The core according to claim 4, wherein a height of said center column is less than or equal to a sum of the heights of said side column and said boss.

6. The core according to claim 4, wherein a height of said center column is equal to a height of said side column.

7. The core according to claim 4, wherein each of said joint face of the side columns at least comprises a first side edge far from said center column and a second side edge near said center column, and said bosses are substantially disposed on both ends of said second side edge.

8. A magnetic element, comprising two cores substantially disposed oppositely, a conductive winding disposed therebetween, and gaps comprised between said two cores, wherein at least one of said two cores comprises:
a plurality of joint faces for jointing the opposed core; and
a plurality of bosses disposed on said joint faces to provide a mechanical support for the opposed core,
wherein the sizes of said gaps are substantially set relative to a height of said bosses.

9. The magnetic element according to claim 8, wherein a sum of the cross-sectional areas of said plurality of bosses on the same joint face is less than the area of the joint face where they are disposed.

10. The magnetic element according to claim 9, wherein a ratio of the sum of the cross-sectional areas of said plurality of bosses on the same joint face to the area of the joint face where they are disposed is less than 1/5.

11. The magnetic element according to any one of claims 8, wherein at least one of said two cores comprises a center column and a plurality of side columns disposed on the periphery of the center column, wherein said plurality of joint faces include a joint face of said center column, and said bosses are disposed on said joint faces of the side columns.

12. The magnetic element according to claim 11, wherein a height of said center column is less than or equal to the sum of the heights of said side column and said boss.

13. The magnetic element according to claim 12, wherein the height of said center column is equal to the height of said side columns.

14. The magnetic element according to claim 12, wherein when the height of said center column is less than the sum of the heights of said side column and said boss, said gaps include:
a first gap formed on the position of said center column; and
a second gap formed on said side columns by said bosses supporting the opposed core.

15. The magnetic element according to claim 14, wherein said second gap has a stepped structure.

16. The magnetic element according to claim 12, wherein when the height of said center column is equal to the sum of the heights of the said side column and said boss, said gaps are formed on said side columns by said bosses supporting the opposed core.

17. The magnetic element according to claim 16, wherein said gaps have a stepped structure.

18. The magnetic element according to claim 11, wherein each said of joint face of the side columns at least comprises a first side edge far from said center column and a second side edge near said center column, and said bosses are substantially disposed on both ends of said second side edge.
